(19) United States
(12) Patent Application Publication
(10) Pub. No.: US 2026/0313747 A1
(43) Pub. Date: Oct. 8, 2026

(54) INDIRECT PATH FAILURE PROCEDURE IN MULTI-PATH

(71) Applicant: LENOVO (BEIJING) LIMITED, Beijing (CN)

(72) Inventor: Lianhai Wu, Beijing (CN)

(21) Appl. No.: 19/480,516

(22) PCT Filed: Dec. 19, 2023
(86) PCT No.: PCT/CN2023/139940

§ 371 Date: Oct. 31, 2025

(51) Int. Cl. H04W 76/30; H04W 76/15; H04W 76/19; H04W 88/02

(52) U.S. Cl. CPC H04W 76/30; H04W 76/15; H04W 76/19; H04W 88/02

(57) ABSTRACT

Example embodiments of the present disclosure relate to a first UE, a second UE, a base station, methods, apparatuses, and computer readable medium for indirect path failure procedure in multi-path scenario. A first UE receives an indication from a second UE which indicates that a connection between the second UE and a third device is failed. The first UE further transmit failure information to the third device or ignore the indication from the second UE. As such, an indirect path failure procedure is discussed, therefore, UE behavior is defined, and the communication between the first UE and the third device is guaranteed.

### TECHNICAL FIELD

The present disclosure relates to wireless communications, and more specifically to network units, methods, apparatuses, and computer readable medium for indirect path failure procedure in multi-path communication.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A scenario of UE-to-network (U2N) relay has been discussed in the third generation partner project (3GPP). An indirect path is a type of U2N transmission path, where data is forwarded via a U2N relay UE between a U2N remote UE and the network.

Currently, intra-gNB based multi-path is being discussed, for example, a UE may communicate with a gNB via a direct path and an indirect path respectively. However, some related issues including indirect path and direct path failure are needed to be further studied.

### SUMMARY

The present disclosure relates to a first UE, a second UE, a base station, methods, apparatuses, and computer readable medium for indirect path failure procedure in multi-path scenario. According to the proposed solution, an indirect path in multi-path may be released based on an indication from the second UE (relay UE).

In some implementations, there is provided a first UE. The first UE comprises at least one memory; and at least one processor coupled with the at least one memory and configured to cause the first UE to: receive, from a second UE, an indication indicating that a connection between the second UE and a third device is failed, wherein the first UE is configured with a direct path between the first UE and the third device and an indirect path between the first UE and the third device via the second UE; and transmit failure information of the indirect path to the third device based on the indication, or ignore the indication from the second UE.

In some implementations, there is provided a first UE. The first UE comprises at least one memory; and at least one processor coupled with the at least one memory and configured to cause the first UE to: transmit, to a second UE, an indication indicating one of: a serving cell of the first UE is different from a further serving cell of the second UE, or unsolicited system information block 1 (SIB1) forwarding is not expected; and ignore the unsolicited SIB1 forwarding from the second UE, wherein the first UE is configured with a direct path between the first UE and a base station (BS) and an indirect path between the first UE and the BS via the second UE.

In some implementations, there is provided a first UE. The first UE comprises at least one memory; and at least one processor coupled with the at least one memory and configured to cause the first UE to: receive, from a BS, a reconfiguration message comprising an identifier of a candidate relay UE, wherein the first UE is configured with a direct path between the first UE and the BS and an indirect path between the first UE and the BS via the second UE; and in accordance with a determination that the candidate relay UE is the same as the second UE, initiate a procedure for releasing the direct path.

In some implementations, there is provided a second UE. The second UE comprises at least one memory; and at least one processor coupled with the at least one memory and configured to cause the second UE to: in response to a connection between the second UE and a third device is failed, transmit, to a first UE, an indication indicating that the connection between the second UE and the third device is failed, wherein the first UE is configured with a direct path between the first UE and the third device and an indirect path between the first UE and the third device via the second UE.

In some implementations, there is provided a BS. The BS comprises at least one memory; and at least one processor coupled with the at least one memory and configured to cause the BS to: receive, from a first UE configured with a direct path between the first UE and the BS and an indirect path between the first UE and the BS via a second UE, failure information of the indirect path; transmit, to the first UE, a path switch message comprising an identifier of a candidate relay UE; and in accordance with a determination that a complete message is received from the first UE, perform switching from the indirect path to a further indirect path, wherein the further indirect path is for a connection between the first UE and the BS via the candidate relay UE.

In some implementations, there is provided a second UE. The second UE comprises at least one memory; and at least one processor coupled with the at least one memory and configured to cause the second UE to: receive, from a first UE or a BS, an indication indicating one of: a serving cell of the first UE is different from a further serving cell of the second UE, or unsolicited SIB1 forwarding is not expected; and desist from, based on the indication, the unsolicited SIB1 forwarding from the BS to the first UE, wherein the first UE is configured with a direct path between the first UE and the BS and an indirect path between the first UE and the BS via the second UE.

In some implementations, there is provided a method performed by the first UE. The method comprises: receiving, from a second UE, an indication indicating that a connection between the second UE and a third device is failed, wherein the first UE is configured with a direct path between the first UE and the third device and an indirect path between the first UE and the third device via the second UE; and transmitting failure information of the indirect path to the third device based on the indication, or ignoring the indication from the second UE.

In some implementations, there is provided a method performed by the first UE. The method comprises: transmitting, to a second UE, an indication indicating one of: a serving cell of the first UE is different from a further serving cell of the second UE, or unsolicited SIB1 forwarding is not expected; and ignoring the unsolicited SIB1 forwarding from the second UE, wherein the first UE is configured with a direct path between the first UE and a BS and an indirect path between the first UE and the BS via the second UE.

In some implementations, there is provided a method performed by the first UE. The method comprises: receiving, from a BS, a reconfiguration message comprising an identifier of a candidate relay UE, wherein the first UE is configured with a direct path between the first UE and the BS and an indirect path between the first UE and the BS via the second UE; and in accordance with a determination that the candidate relay UE is the same as the second UE, initiating a procedure for releasing the direct path.

In some implementations, there is provided a method performed by the second UE. The method comprises: in response to a connection between the second UE and a third device is failed, transmitting, to a first UE, an indication indicating that the connection between the second UE and the third device is failed, wherein the first UE is configured with a direct path between the first UE and the third device and an indirect path between the first UE and the third device via the second UE.

In some implementations, there is provided a method performed by the BS. The method comprises: receiving, from a first UE configured with a direct path between the first UE and the BS and an indirect path between the first UE and the BS via a second UE, failure information of the indirect path; transmitting, to the first UE, a path switch message comprising an identifier of a candidate relay UE; and in accordance with a determination that a complete message is received from the first UE, performing switching from the indirect path to a further indirect path, wherein the further indirect path is for a connection between the first UE and the BS via the candidate relay UE.

In some implementations, there is provided a method performed by the second UE. The method comprises: receiving, from a first UE or a BS, an indication indicating one of: a serving cell of the first UE is different from a further serving cell of the second UE, or unsolicited SIB1 forwarding is not expected; and desisting from, based on the indication, the unsolicited SIB1 forwarding from the BS to the first UE, wherein the first UE is configured with a direct path between the first UE and the BS and an indirect path between the first UE and the BS via the second UE.

In some implementations, there is provided a processor for wireless communication. The processor comprises at least one controller coupled with at least one memory and configured to cause the processor to: receive, from a second UE, an indication indicating that a connection between the second UE and a third device is failed, wherein the first UE is configured with a direct path between the first UE and the third device and an indirect path between the first UE and the third device via the second UE; and transmit failure information of the indirect path to the third device based on the indication, or ignore the indication from the second UE.

In some implementations, there is provided a processor for wireless communication. The processor comprises at least one controller coupled with at least one memory and configured to cause the processor to: transmit, to a second UE, an indication indicating one of: a serving cell of the first UE is different from a further serving cell of the second UE, or unsolicited SIB1 forwarding is not expected; and ignore the unsolicited SIB1 forwarding from the second UE, wherein the first UE is configured with a direct path between the first UE and a BS and an indirect path between the first UE and the BS via the second UE.

In some implementations, there is provided a processor for wireless communication. The processor comprises at least one controller coupled with at least one memory and configured to cause the processor to: receive, from a BS, a reconfiguration message comprising an identifier of a candidate relay UE, wherein the first UE is configured with a direct path between the first UE and the BS and an indirect path between the first UE and the BS via the second UE; and in accordance with a determination that the candidate relay UE is the same as the second UE, initiate a procedure for releasing the direct path.

In some implementations, there is provided a processor for wireless communication. The processor comprises at least one controller coupled with at least one memory and configured to cause the processor to: in response to a connection between the second UE and a third device is failed, transmit, to a first UE, an indication indicating that the connection between the second UE and the third device is failed, wherein the first UE is configured with a direct path between the first UE and the third device and an indirect path between the first UE and the third device via the second UE.

In some implementations, there is provided a processor for wireless communication. The processor comprises at least one controller coupled with at least one memory and configured to cause the processor to: receive, from a first UE configured with a direct path between the first UE and the BS and an indirect path between the first UE and the BS via a second UE, failure information of the indirect path; transmit, to the first UE, a path switch message comprising an identifier of a candidate relay UE; and in accordance with a determination that a complete message is received from the first UE, perform switching from the indirect path to a further indirect path, wherein the further indirect path is for a connection between the first UE and the BS via the candidate relay UE.

In some implementations, there is provided a processor for wireless communication. The processor comprises at least one controller coupled with at least one memory and configured to cause the processor to: receive, from a first UE or a BS, an indication indicating one of: a serving cell of the first UE is different from a further serving cell of the second UE, or unsolicited SIB1 forwarding is not expected; and desist from, based on the indication, the unsolicited SIB1 forwarding from the BS to the first UE, wherein the first UE is configured with a direct path between the first UE and the BS and an indirect path between the first UE and the BS via the second UE.

In some implementations of the methods and the first UE described herein, the third device is a BS, further comprising: receiving, from the BS, a path switch message comprising an identifier of a candidate relay UE; and performing, based on the path switch message, switching from the indirect path to a further indirect path, wherein the further indirect path is for a connection between the first UE and the BS via the candidate relay UE.

In some implementations of the methods and the first UE described herein, the third device is a BS, further comprising: in accordance with a determination that the indication indicates a handover of the second UE, ignoring the indication.

In some implementations of the methods and the first UE described herein, further comprising: keeping the indirect path unchanged; and performing a primary cell (PCell) change from a first cell associated with the direct path to a second cell associated with the indirect path.

In some implementations of the methods and the first UE described herein, further comprising: in accordance with a determination that a timer for path addition or path change is running, determining to use resources configured in configured sidelink grant for the second UE.

In some implementations of the methods, the first UE, the second UE, and the BS described herein, the third device is a BS, and the indication indicates one of the following: a radio link failure (RLF) of a link between the second UE and the BS, a handover of the second UE, or a cell reselection of the second UE.

In some implementations of the methods, the first UE, the second UE, and the BS described herein, the indication is carried in a PC5 notification message.

In some implementations of the methods, the first UE, the second UE, and the BS described herein, the indication comprises a PC5 unicast release message.

In some implementations of the methods, the first UE, the second UE, and the BS described herein, the third device is a third UE, and the indication indicates one of the following: a PC5 RLF between the second UE and the third UE, or a sidelink radio resource control (RRC) reconfiguration failure between the second UE and the third UE.

In some implementations of the methods, the first UE, the second UE, and the BS described herein, the indication comprises a failure type indicating the sidelink RRC reconfiguration failure.

In some implementations of the methods, the first UE, the second UE, and the BS described herein, the failure information of the indirect path comprises a failure type of the indirect path, and wherein the failure type indicates one of the following: an RLF of a link between the second UE and the BS, a handover of the second UE, or a cell reselection of the second UE.

In some implementations of the methods, the first UE, the second UE, and the BS described herein, the indication from the BS is carried in an RRC reconfiguration message.

### BRIEF DESCRIPTION OF THE DRAWINGS

FIG. 1 illustrates an example of a wireless communications system in which some embodiments of the present disclosure can be implemented;

FIG. 2A illustrates a schematic diagram of an example communication network in which some embodiments of the present disclosure can be implemented;

FIG. 2B illustrates an example RRC reconfiguration sidelink procedure;

FIG. 2C illustrates an example flow signalling for successful indirect path addition;

FIG. 2D illustrates a schematic diagram of an example communication network in which some embodiments of the present disclosure can be implemented;

FIG. 3 illustrates a signalling chart illustrating communication process in accordance with some example embodiments of the present disclosure;

FIG. 4 illustrates a schematic diagram of signalling transmission in accordance with some example embodiments of the present disclosure;

FIG. 5 illustrates a signalling chart illustrating communication process for unsolicited SIB1 in accordance with some example embodiments of the present disclosure;

FIG. 6 illustrates a signalling chart illustrating communication process for direct path release in accordance with some example embodiments of the present disclosure;

FIG. 7 illustrates a signalling chart illustrating communication process for single path switch in accordance with some example embodiments of the present disclosure;

FIG. 8A illustrates a schematic diagram of a U2U network in which some embodiments of the present disclosure can be implemented;

FIG. 8B illustrates a signalling chart illustrating communication process for indirect path failure in U2U in accordance with some example embodiments of the present disclosure;

FIG. 9 illustrates an example of a device that is suitable for implementing embodiments of the present disclosure;

FIG. 10 illustrates an example of a processor that is suitable for implementing some embodiments of the present disclosure;

FIG. 11 illustrates a flowchart of an example method implemented at a first UE in accordance with aspects of the present disclosure;

FIG. 12 illustrates a flowchart of an example method implemented at a first UE in accordance with aspects of the present disclosure;

FIG. 13 illustrates a flowchart of an example method implemented at a first UE in accordance with aspects of the present disclosure;

FIG. 14 illustrates a flowchart of an example method implemented at a second UE in accordance with aspects of the present disclosure;

FIG. 15 illustrates a flowchart of an example method implemented at a BS in accordance with aspects of the present disclosure; and

FIG. 16 illustrates a flowchart of an example method implemented at a second UE in accordance with some embodiments of the present disclosure.

Throughout the drawings, the same or similar reference numerals represent the same or similar element.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

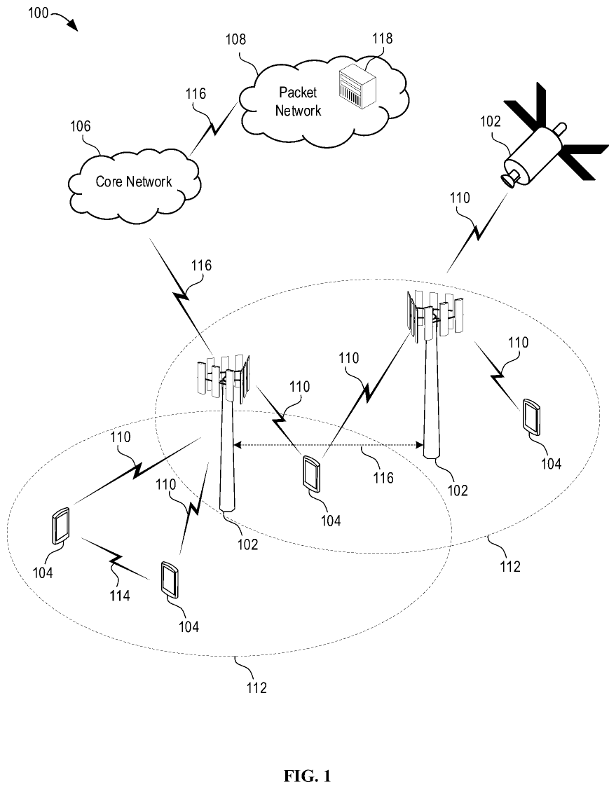

FIG. 1 illustrates an example of a wireless communications system 100 in which some embodiments of the present disclosure can be implemented. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as a long term evolution (LTE) network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, message, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink (SL). For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N3, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-C, F1-U), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N3, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the context of the present disclosure, the term “proximity communication 5 (PC5) link” may be used interchangeably with PC5 interface, sidelink (SL), PC5 unicast link, SL unicast link, device-to-device (D2D) link, user-to-user link, UE-to-UE (U2U) link, or the like. The term “relay UE” may be used interchangeably with U2N relay UE, U2U relay UE, layer 2 (L2) relay UE, L2 U2N relay UE, L2 U2U relay UE, or the like. The term “relay UE ID” may be used interchangeably with link ID, path ID, L2 relay UE ID, or the like.

A wireless communications system may include one or more devices, such as one or more base stations and/or one or more UEs. In some implementations, two different UEs may communicate with each other via a PC5 link (PC5 interface), two different base stations may communicate with each other via an Xn link (Xn interface), and a UE and a base station may communicate with each via a Uu link (Uu interface).

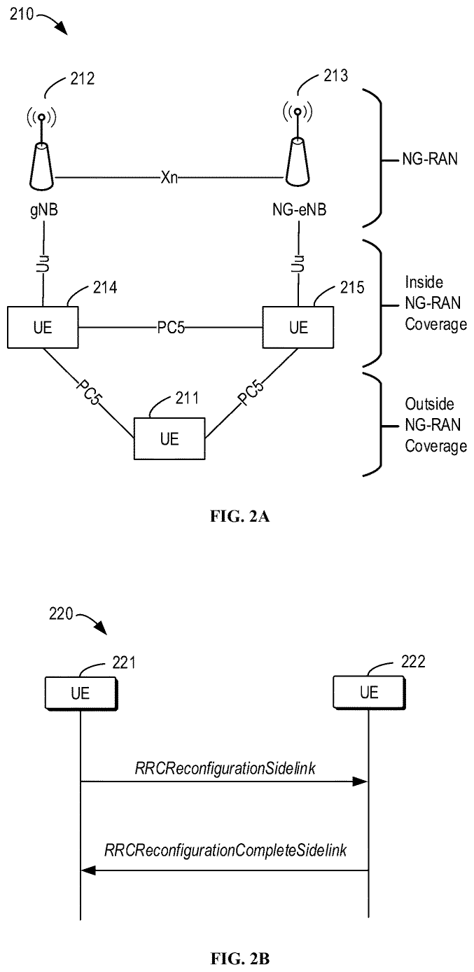

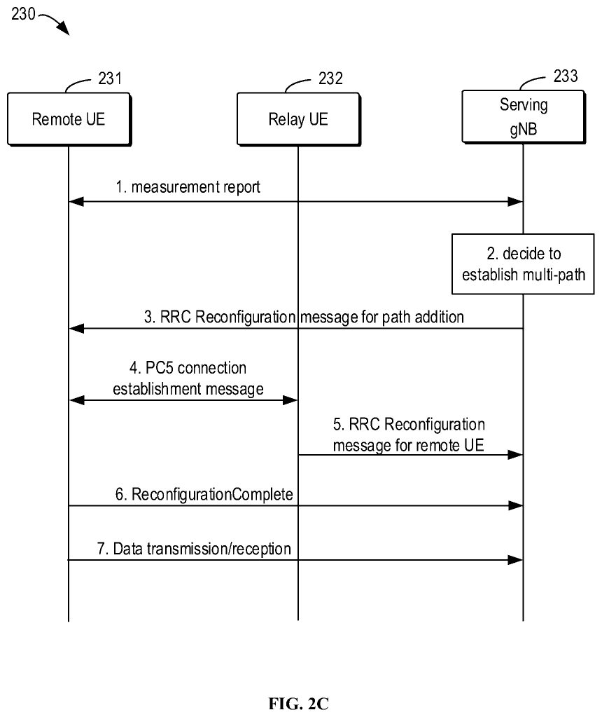

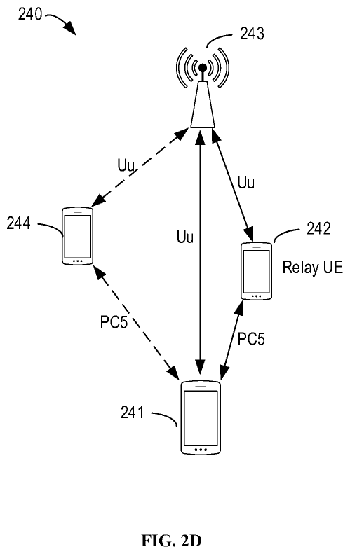

FIG. 2A illustrates a schematic diagram of an example communication network 210 in which some embodiments of the present disclosure can be implemented. As shown in FIG. 2A, a UE 211 may communicate with a base station via a relay UE. The base station may be a gNB 212 or an NG-eNB 213, and the relay UE may be a relay UE 214 or a relay UE 215. For example, the NG-eNB 213 may be an evolved long term evolution (eLTE) base station that supports an NG interface. In some embodiments, the sidelink transmission and reception over the PC5 link are supported when the UE 211 is inside Next Generation Radio Access Network (NG-RAN) coverage, irrespective of which RRC state the UE is in, and also supported and when the UE 211 is outside NG-RAN coverage.

FIG. 2B illustrates an example RRC reconfiguration sidelink procedure 220. A shown in FIG. 2B, a UE 221 may transmit an RRCReconfigurationSidelink message to a UE 222, and the UE 222 may transmit an RRCReconfigurationCompleteSidelink message back to the UE 221.

The purpose of the procedure 220 is to modify a PC5-RRC connection, e.g. to establish/modify/release sidelink data radio bearers (DRBs), to configure NR sidelink measurement and reporting, to configure sidelink channel state indicator (CSI) reference signal resources.

The UE (such as the UE 221) may initiate the sidelink RRC reconfiguration procedure and perform an operation on the corresponding PC5-RRC connection in following cases:
the release of sidelink DRBs associated with the peer UE (such as the UE 222),
the establishment of sidelink DRBs associated with the peer UE,
the modification for the parameters included in sidelink radio bearer-configuration (SLRB-Config) of sidelink DRBs associated with the peer UE,
the configuration of the peer UE to perform NR sidelink measurement and report,
the configuration of the sidelink CSI reference signal resources.

FIG. 2C illustrates an example flow signalling 230 for successful second indirect path addition. Specifically, a remote UE 231 may perform a measurement report to the serving gNB 233 at step 1. A second indirect path via a relay UE may be decided to be added by the serving gNB 233 at step 2. In addition, at step 3, an RRC reconfiguration for path addition may be transmitted from the serving gNB 233 to the remote UE 231. Accordingly, a PC5 connection between the remote UE 231 and the relay UE 232 may be established based on a PC5 connection establishment message at step 4, and an RRC reconfiguration message for remote UE 231 may be transmitted from the serving gNB 233 to the relay UE 232. As such, an indicate path is added after an RRC reconfiguration complete message at step 6, and data transmission or reception at step 7 may be performed.

In a multi-path scenario, a remote UE may be configured with multiple paths, e.g. including a direct path and an indirect path. 3GPP is discussing a possibility of a failure type of the indirect path, for example, an IE for a failure report of the indirect path may involve a failure type including e.g., timer expiry, sl-Failure, n3c-Failure, relayUE-Uu-RLF, relayUE-CellReselection, relayUE-Uu-RRC-Failure, indirectPathAddChangeFailure.

Embodiments of the present disclosure provide a solution of communication. In the solution, a relay UE may transmit an indication to the remote UE to indicate a failure of the connection between the relay UE and the BS, and accordingly the remote UE may further transmit failure information to the BS or ignore the indication. As such, behaviors of the UEs may be defined in case a failure of the indirect path, and therefore a communication for the remote UE may be guaranteed. Principles and implementations of the present disclosure will be described in detail below with reference to the figures.

FIG. 2D illustrates a schematic diagram of an example communication network 240 in which some embodiments of the present disclosure can be implemented. As shown in FIG. 2D, the communication network 240 may include a first UE 241, a second UE 242, and a BS 243.

The BS 243 and the first UE 241 may communicate with each other via a direct path. For example, the direct path may be associated with a Uu link there between. For example, the BS 243 may be a serving network device of the first UE 241, such as a serving gNB. There may be an indirect path between the first UE 241 and the BS 243 via the second UE 242. For example, the BS 243 may communicate with the second UE 242 via a Uu link, and the second UE 242 may communicate with the first UE 241 via a PC5 link. In this case, the first UE 241 may be a remote UE, the second UE 242 may be a relay UE. It is to be understood that the multi-path scenario may be based on a DC framework or a non-DC framework, the present disclosure does not limit this aspect.

In some cases, as shown in FIG. 2D, there may be a third UE 244, for example, the first UE 241 and the BS 243 may communicate with each other via the third UE 244.

It is to be understood that the number of devices in FIG. 2D is given for the purpose of illustration without suggesting any limitations to the present disclosure.

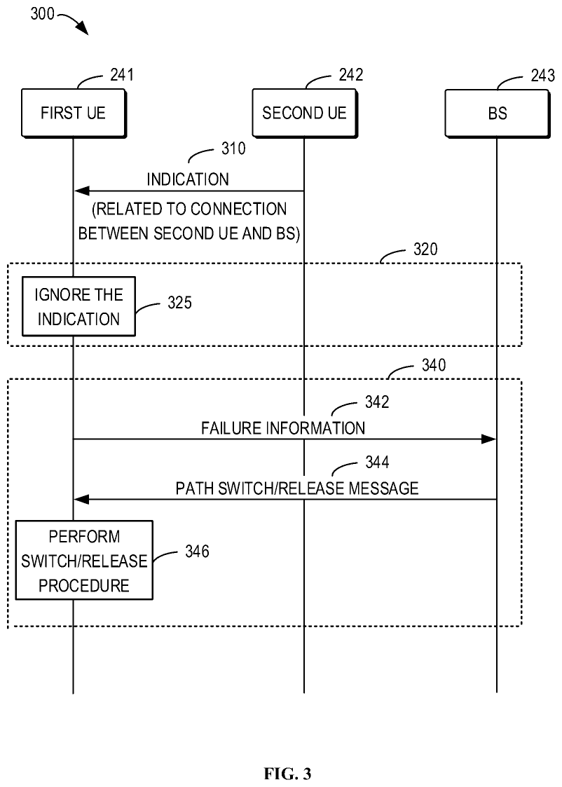

Reference is further made to FIG. 3, which illustrates a signalling chart illustrating communication process 300 in accordance with some example embodiments of the present disclosure. The process 300 may involve the first UE 241, the second UE 242, and the BS 243 as shown in FIG. 2D. It is to be understood that the process 300 may also be applied to another scenario different from that shown in FIG. 2D, the present disclosure does not limit this aspect.

The first UE 241 may be in (i.e., stays at) an RRC connected state, and the first UE 241 is configured with multi-path including at least one direct path and at least one indirect path. The first UE 241 may access the BS 243 (such as serving gNB) via a direct path and an indirect path (via the second UE 242). In some example embodiments, the first UE 241 may transmit measurement results to the BS 243. In some examples, the first UE 241 may report the measurement results associated with one or more candidate cells or candidate relay UEs, based on a configuration from the BS 243.

In the process 300, the second UE 242 transmits an indication to the first UE 241 at 310, where the indication may indicate a failure of a connection between the second UE 242 and the BS 243.

In some implementations, the second UE 242 may determine whether a failure of a connection between the second UE 242 and the BS 243 occurs. In some examples, if one of the following cases occurs, the second UE 242 may determine to transmit the indication to the first UE 241: an RLF of a link between the second UE 242 and the BS 243, a handover of the second UE 242, a cell reselection of the second UE 242, an RRC connection establishment or resume failure. In some examples, if the second UE 242 receives a handover command from the BS 243, it may determine to transmit the indication.

In some implementations, the indication may be carried in a PC5 notification message. For example, the second UE 242 may transmit a PC5 notification message to the first UE 241 at 310, where the PC5 notification message includes information indicates a failure of the connection between the second UE 242 and the BS 243.

In some other implementations, the indication is a PC5 unicast release message (a PC5-S release message, or a release message). For example, the second UE 242 may transmit a release message to the first UE 241 at 310, where the release message may indicate a failure of the connection between the second UE 242 and the BS 243.

In some implementations, the indication at 310 may include a failure type (or a cause value) indicating a reason of the failure of the connection between the second UE 242 and the BS 243. For example, the failure type may indicate a handover of the second UE 242, for example, the second UE 242 has handed over to another BS different from the BS 243. For example, the failure type may indicate an RLF of the Uu link, for example, an RRC connection reestablishment or resume is failed. In this case, the first UE 241 may be aware of the reason of the failure.

In the process 300, upon receiving the indication from the second UE 242, the first UE 241 may perform the operation 320 or the operation 340 shown in FIG. 3.

In some example embodiments, the first UE 241 may ignore the indication at 325. In some examples, the second UE 242 may receive a handover command from its serving BS, and then the second UE 242 may transmit the indication. In some examples, the first UE 241 receives the indication and the indication indicates that a handover of the second UE 242, then the first UE 241 may ignore the indication. For example, a reconfiguration with synchronization of the second UE 242 may be indicated by the indication, e.g. by a failure type in the indication. In this case, the indication from the second UE 242 is ignored by the first UE 241 due to a handover of the second UE 242.

In some example embodiments, the first UE 241 transmits failure information to the BS 243 at 342. In some examples, the first UE 241 may initiate a procedure of an indirect path failure upon receiving the indication from the second UE 242 (i.e. a PC5 unicast release message or a notification message). For example, the failure information may be carried in or be implemented as an IndirectPathFailureInformation message.

In some examples, the failure information (or the IndirectPathFailureInformation message) may include a failure type for the indirect path associated with the second UE 242.

In some examples, the failure information (or the IndirectPathFailureInformation message) may include measurement results for one or more candidate relay UEs.

The BS 243 transmits a path switch message (or a path release message) to the first UE 241 at 344. In some implementations, the BS 243 may release the indirect path upon receiving the failure information. The BS 243 may transmit the path release message to the first UE 241 at 344, and in addition, the first UE 241 may release, at 346, the indirect path according to the path release message.

In some implementations, the BS 243 transmit the path switch message to the first UE 241 at 344, and the path switch message may indicate a candidate relay UE. In some examples, the BS 243 may configure a new relay UE (i.e. the indicated candidate relay UE) to the first UE 241, for example, the path switch message may include an ID of the candidate relay UE. With reference to FIG. 2D, the candidate relay UE may be the third UE 244.

In some examples, the path switch message may be replaced by a reconfiguration message associated with the candidate relay UE, for example, the reconfiguration message includes configuration information of the candidate relay UE. In addition, the first UE 241 may perform a path switch procedure at 346 according to the path switch message. For example, an indirect path via the second UE 242 may be switched to another indirect path via the third UE 244.

In some examples, the first UE 241 may transmit an RRC reconfiguration complete message to the BS 243 to indicate that the path switch procedure has been successfully. For example, the BS 243 may perform the indirect path switch upon receiving the complete message from the first UE 241. Therefore, the first UE 241 may still communicate with the BS 243 via a direct path and an indirect path.

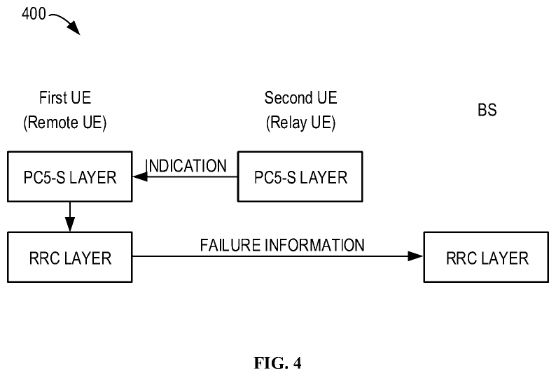

FIG. 4 illustrates a schematic diagram of signalling transmission 400 in accordance with some example embodiments of the present disclosure. As shown in FIG. 4, the indication from the second UE to the first UE may be transmitted in the PC5 signalling (PC5-S) layer, while the failure information from the first UE to the BS may be transmitted in the RRC layer.

The PC5-S layer of the second UE (relay UE) may transmit the indication (e.g. release message) to the first UE (remote UE), the PC5-S layer of the first UE may indicate to the RRC layer of the first UE, in addition, the RRC layer of the first UE may trigger a transmission of the failure information (e.g., the IndirectPathFailureInformation message). In some examples, an indication from an upper layer may be regarded as a trigger condition of an indirect path failure procedure for the RRC layer of the first UE.

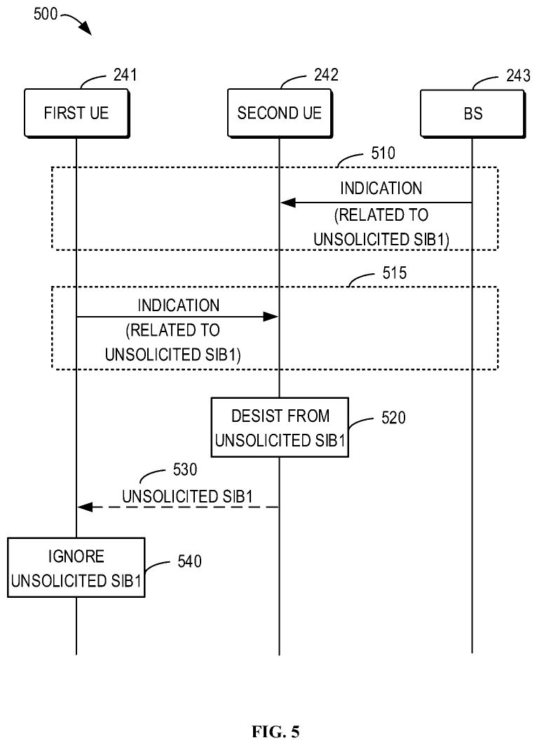

FIG. 5 illustrates a signalling chart illustrating communication process 500 for unsolicited SIB1 in accordance with some example embodiments of the present disclosure. The process 500 may involve the first UE 241, the second UE 242, and the BS 243 as shown in FIG. 2D. It is to be understood that the process 500 may also be applied to another scenario different from that shown in FIG. 2D, the present disclosure does not limit this aspect.

The first UE 241 may be in (i.e., stays at) an RRC connected state, and the first UE 241 is configured with multi-path including at least one direct path and at least one indirect path. The first UE 241 may access the BS 243 (such as serving gNB) via a direct path and an indirect path (via the second UE 242). In some example embodiments, the first UE 241 may transmit measurement results to the BS 243. In some examples, the first UE 241 may report the measurement results associated with one or more candidate cells or candidate relay UEs, based on a configuration from the BS 243.

In the process 500, operation 510 and/or operation 515 may be performed. At 510, the BS 243 transmits an indication to the second UE 242. In some implementations, the BS 243 may transmit a reconfiguration message to the second UE 242, where the reconfiguration message may include the indication. In some examples, the indication may indicate that a serving BS of the first UE 241 is different from a serving BS of the second UE 242. In some examples, the indication may indicate not to perform unsolicited SIB1 forwarding to the first UE 241.

At 515, the first UE 241 transmits an indication to the second UE 242. In some examples, the indication may indicate that a serving BS of the first UE 241 is different from a serving BS of the second UE 242. In some examples, the indication may indicate not to perform unsolicited SIB1 forwarding to the first UE 241, that is, an unsolicited SIB1 forwarding is not expected.

In the process 500, the second UE 242 desists from the unsolicited SIB1 forwarding at 520 according to the indication from the BS 243 and/or the first UE 241. In some implementations, the second UE 242 may not perform (or stop/avoid) unsolicited SIB1 forwarding to the first UE 241.

In some cases, if some unsolicited SIB1 is forwarded from the second UE 242 to the first UE 241 at 530, the first UE 241 may ignore the unsolicited SIB1 forwarded from the second UE 242 at 540. For example, if the serving cells (or serving BSs) of the first UE 241 and the second UE 242 are different, then the system information (e.g. SIB1) forwarded from the second UE 242 may be ignored.

It is to be understood that, in 3GPP release 17 (R17). a relay UE would forward SIB1 in unsolicited way, however, in multi-path scenario, the serving cells of a remote UE and a relay UE may be different, in this case, the forwarded SIB1 is useless and result in additional signaling overhead. According to embodiments with reference to FIG. 5, the unsolicited SIB1 forwarding may be avoided, and thus signaling overhead may be reduced. In case the unsolicited SIB1 is forwarded to the remote UE, it may be neglected, and thus further operation at the remote UE may be avoided.

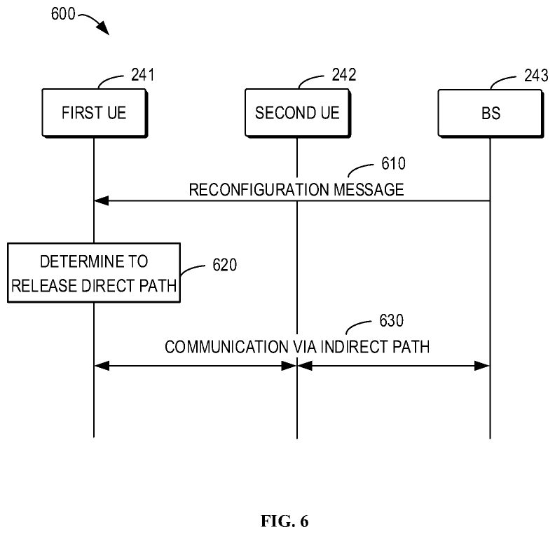

FIG. 6 illustrates a signalling chart illustrating communication process 600 for direct path release in accordance with some example embodiments of the present disclosure. The process 600 may involve the first UE 241, the second UE 242, and the BS 243 as shown in FIG. 2D. It would be appreciated that the process 600 may be applied to other communication scenarios, which will not be described in detail.

The first UE 241 may be in (i.e., stays at) an RRC connected state, and the first UE 241 is configured with multi-path including at least one direct path and at least one indirect path. The first UE 241 may access the BS 243 (such as serving gNB) via a direct path and an indirect path (via the second UE 242). In some example embodiments, the first UE 241 may transmit measurement results to the BS 243. In some examples, the first UE 241 may report the measurement results associated with one or more candidate cells or candidate relay UEs, based on a configuration from the BS 243. In some examples, a PCell is configured in the direct path.

In the process 600, the BS 243 transmits a reconfiguration message to the first UE 241 at 610. In some implementations, the reconfiguration message may be associated with a direct path release. In some implementations, the reconfiguration message may indicate a candidate relay UE, for example, the reconfiguration message may include an ID of the candidate relay UE.

In some example embodiments, the BS 243 may determine to release the direct path between the BS 243 and the first UE 241, in this event the PCell will be changed from the direct path to the indirect path.

In some examples, the indication may be included in an RRC reconfiguration with synchronization (reconfigurationWithSync) message or in an sidelink indirect path add change (SL-IndirectPathAddChange) message.

In some examples, the reconfiguration message may be regarded as an implicit direct path release message.

In the process 600, the first UE 241 determines to release the direct path at 620. In some implementations, after receiving the indication from the BS 243 (the reconfiguration message), the first UE 241 may determine whether the candidate relay UE indicated in the indication is the same as the second UE 242 of the indirect path. In some implementations, if the indicated candidate relay UE is the same as the second UE 242 of the indirect path, the first UE 241 may initiate (or perform) a direct path release procedure.

In some examples, the indication may include an ID of a candidate relay UE, which is the same as the ID of the second UE 242. In some implementations, the first UE 241 may release the direct path, and may keep (maintain) the indirect path via the second UE 242.

If considering the case that the first UE 241 is configured with two paths including a direct path and an indirect path, the link between the remote UE (the first UE 241) and the relay UE (the second UE 242) may be out-of-3GPP link e.g., Bluetooth. When the remote UE (the first UE 241) receives reconfiguration message for indirect path change or addition, a timer for indirect path addition or change in the case of multi-path is started. That is, the remote UE (the first UE 241) starts the timer upon reception of the RRCReconfiguration message including n3c-indirectPathAddChange. The remote UE (the first UE 241) stops the timer upon (successfully) sending RRCReconfigurationComplete message.

In some implementations, if the timer for path addition or path change is still running, the first UE 241 may determine to use the resources configured for the path addition or path change, e.g. in configured sidelink grant for the second UE 242.

In some example embodiments, in case the RRC reconfiguration with synchronization (reconfigurationWithSync) message is used for the indication, the first UE 241 may use the resources configured in rrc-ConfiguredSidelinkGrant (while T420 is running), e.g. if provided by the target cell. In some example embodiments, in case a path switching procedure is reused, for example, the sidelink indirect path add change (SL-IndirectPathAddChange) message may be used for the indication, the first UE 241 may use configured grant for sidelink while the timer for path switching (e.g. T420) is running, e.g. if provided by the target cell.

In some implementations, the first UE 241 may perform a PCell change from the direct path to the indirect path. For example, the PCell is changed from a first cell associated with the direct path to a second cell associated with the indirect path.

As such, the direct path between the first UE 241 and the BS 243 is released, and the first UE 241 may further perform communication with the BS 243 by the indirect path via the second UE 242 at 630. In other words, the first UE 241 may transmit/receive data to/from the BS 243 via the second UE 242.

According to some embodiments with reference to FIGS. 3-6, some issues related to multi-path are discussed, therefore, UE behavior is defined, signalling overhead may be reduced, and unnecessary operations may be avoided.

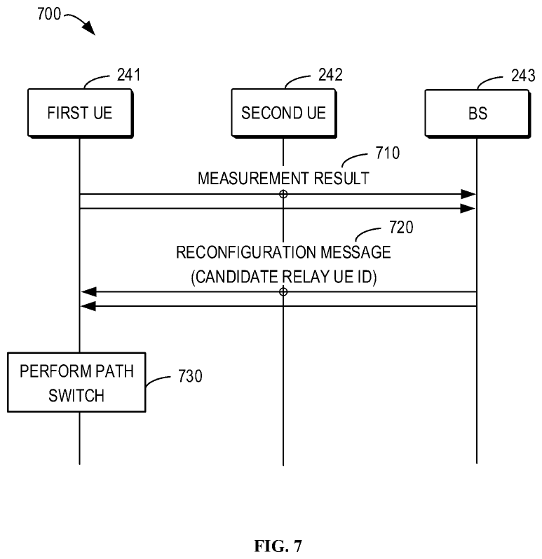

FIG. 7 illustrates a signalling chart illustrating communication process 700 for single path switch in accordance with some example embodiments of the present disclosure. The process 700 may involve the first UE 241, the second UE 242, and the BS 243 as shown in FIG. 2D. It would be appreciated that the process 700 may be applied to other communication scenarios, which will not be described in detail.

The first UE 241 may be in (i.e., stays at) an RRC connected state, and the first UE 241 is configured with a single path, which may be a direct path or an indirect path. For example, the first UE 241 may access the BS 243 (such as serving gNB) via a direct path or an indirect path (via the second UE 242).

In the process 700, the first UE 241 transmits a measurement result to the BS 243 at 710. In some implementations, the measurement result is transmitted via the single path, that is the direct path or the indirect path. In some implementations, the measurement result may be associated with one or more candidate cells or candidate relay UEs, based on a configuration from the BS 243.

In the process 700, the BS 243 transmits a reconfiguration message to the first UE 241 at 720. The reconfiguration message may indicate a candidate relay UE, for example, the reconfiguration message may include an ID of the candidate relay UE.

In some implementations, the BS 243 may determine to perform path switch towards a candidate relay UE, based on the measurement result from the first UE 241. In some implementations, the reconfiguration message may be regarded as for path switch purpose.

In some implementations, the reconfiguration message may include a configured grant for sidelink, which is associated with the candidate relay UE.

In the process 700, the first UE 241 performs a path switch procedure at 730. In some implementations, when the first UE 241 receives the reconfiguration message indicating the candidate relay UE, the first UE 241 may initiate a path switch procedure according to the reconfiguration message. In some examples, the first UE 241 may start a timer (such as T420) for the path switch procedure.

In some example embodiments, in case the RRC reconfiguration with synchronization (reconfiguration WithSync) message is received, the first UE 241 may use the resources configured in rrc-ConfiguredSidelinkGrant (while T420 is running), e.g. if provided by the target cell. In some example embodiments, in case of path switching, the first UE 241 may use configured grant for sidelink while the timer for path switching (e.g. T420) is running, e.g. if provided by the target cell.

In some implementations, the first UE 241 may transmit an RRC reconfiguration complete message to the BS 243 to indicate that the path switch procedure has been successfully. For example, the BS 243 may perform the indirect path switch upon receiving the complete message from the first UE 241. Therefore, the first UE 241 may communicate with the BS 243 via a new indirect path (via the candidate relay UE). In other words, the first UE 241 may transmit/receive data to/from the BS 243 via the candidate relay UE.

According to some embodiments with reference to FIG. 7, a path switch procedure is discussed for a single path scenario, therefore, UE behavior is defined, and the communication between the first UE and the BS is maintained.

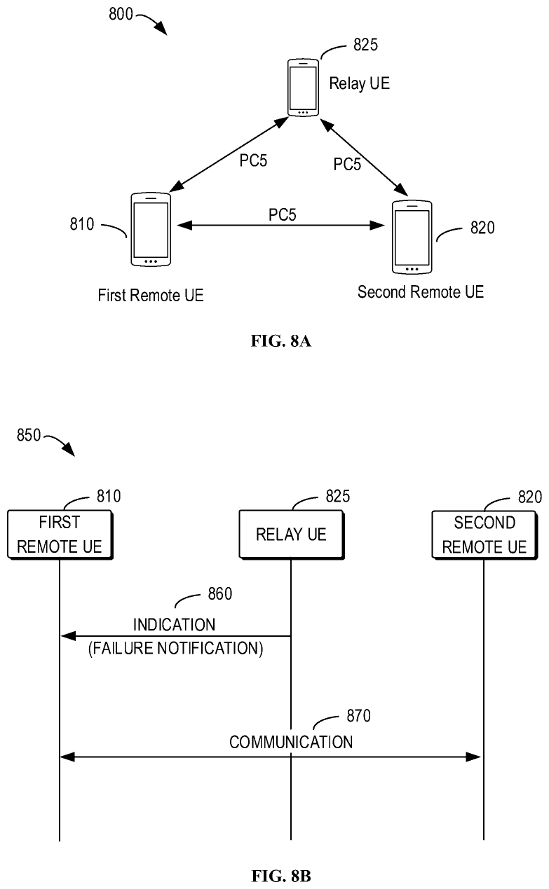

FIG. 8A illustrates a schematic diagram of a U2U network 800 in which some embodiments of the present disclosure can be implemented. As shown in FIG. 8A, the U2U network 800 may include a first remote UE 810, a second remote UE 820, and a relay UE 825.

The first remote UE 810 and the second remote UE 820 may communicate with each other via a direct path. For example, the direct path may be associated with a PC5 link there between. The first remote UE 810 and the second remote UE 820 may communicate with each other via an indirect path. For example, the first remote UE 810 may communicate with the relay UE 825 via a PC5 link, and the relay UE 825 may communicate with the second remote UE 820 via a PC5 link.

It is to be understood that the number of devices in FIG. 8A is given for the purpose of illustration without suggesting any limitations to the present disclosure.

FIG. 8B illustrates a signalling chart illustrating communication process 850 for indirect path failure in U2U in accordance with some example embodiments of the present disclosure. The process 850 may involve the first remote UE 810 the second remote UE 820, and the relay UE 825 as shown in FIG. 8A. It would be appreciated that the process 850 may be applied to other communication scenarios, which will not be described in detail.

The first remote UE 810 communicates with the second remote UE 820 via a direct path or an indirect path. For example, the first remote UE 810 may communicate with the second remote UE 820 directly. For example, the first remote UE 810 may communicate with the second remote UE 820 via the relay UE 825. The PC5 RRC connection has been established between the first UE 810 and the relay UE 825, and the PC5 RRC connection has been established between the second UE 820 and the relay UE 825.

In the process 850, the relay UE 825 transmits an indication to the first remote UE 810 at 860, the indication may indicate a failure of a connection between the relay UE 825 and the second remote UE 820. For example, the indication may be a failure notification message.

In some implementations, when the relay UE 825 detects a PC5 RLF of a link between the second remote UE 820 and the relay UE 825, the relay UE 825 may transmit the failure notification message to the first remote UE 810. In some other implementations, when the relay UE 825 receives a sidelink RRC configuration failure message from the second remote UE 820, the relay UE 825 may transmit the failure notification message to the first remote UE 810.

In some example embodiments, the failure notification message may indicate a failure type of the link between the second remote UE 820 and the relay UE 825. For example, the failure type may indicate a PC5 RLF of a link between the second remote UE 820 and the relay UE 825. For example, the failure type may indicate a sidelink RRC configuration failure between the second remote UE 820 and the relay UE 825. For example, the IE “NotificationMessageSidelink” includes sl-Indication Type and destination identity.

In some implementations, the first remote UE 810 may release the indirect path, and the first remote UE 810 may further perform communication with the second remote UE 820 via the direct path at 870. In other words, the first remote UE 810 may transmit/receive data to/from the second remote UE 820 via the direct path.

According to embodiments shown in FIGS. 8A-8B, an issue of how to handle sidelink RRC reconfiguration failure in U2U relay is solved, therefore, UE behavior is defined and a U2U communication is guaranteed.

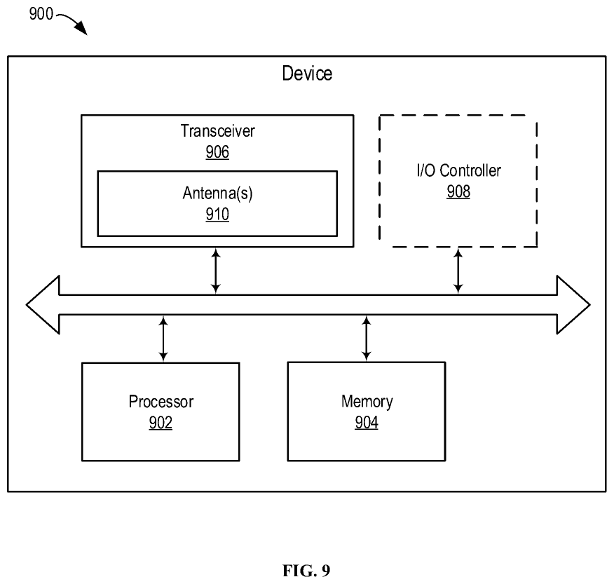

FIG. 9 illustrates an example of a device 900 that is suitable for implementing embodiments of the present disclosure. The device 900 may be an example of a RAN node as described herein. The device 900 may support wireless communication with the first UE 241, the second UE 242, the BS 243, the first remote UE 810, the relay UE 825, or any combination thereof. The device 900 may include components for bi-directional communications including components for transmitting and receiving communications, such as a processor 902, a memory 904, a transceiver 906, and, optionally, an I/O controller 908. These components may be in electronic communication or otherwise coupled (e.g., operatively, communicatively, functionally, electronically, electrically) via one or more interfaces (e.g., buses).

The processor 902, the memory 904, the transceiver 906, or various combinations thereof or various components thereof may be examples of means for performing various aspects of the present disclosure as described herein. For example, the processor 902, the memory 904, the transceiver 906, or various combinations or components thereof may support a method for performing one or more of the operations described herein.

In some implementations, the processor 902, the memory 904, the transceiver 906, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 902 and the memory 904 coupled with the processor 902 may be configured to perform one or more of the functions described herein (e.g., executing, by the processor 902, instructions stored in the memory 904).

For example, the processor 902 may support wireless communication at the device 900 in accordance with examples as disclosed herein. The processor 902 may be configured to operable to support a means for actions discussed above.

The processor 902 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 902 may be configured to operate a memory array using a memory controller. In some other implementations, a memory controller may be integrated into the processor 902. The processor 902 may be configured to execute computer-readable instructions stored in a memory (e.g., the memory 904) to cause the device 900 to perform various functions of the present disclosure.

The memory 904 may include random access memory (RAM) and read-only memory (ROM). The memory 904 may store computer-readable, computer-executable code including instructions that, when executed by the processor 902 cause the device 900 to perform various functions described herein. The code may be stored in a non-transitory computer-readable medium such as system memory or another type of memory. In some implementations, the code may not be directly executable by the processor 902 but may cause a computer (e.g., when compiled and executed) to perform functions described herein. In some implementations, the memory 904 may include, among other things, a basic I/O system (BIOS) which may control basic hardware or software operation such as the interaction with peripheral components or devices.

The I/O controller 908 may manage input and output signals for the device 900. The I/O controller 908 may also manage peripherals not integrated into the device M02. In some implementations, the I/O controller 908 may represent a physical connection or port to an external peripheral. In some implementations, the I/O controller 908 may utilize an operating system such as iOS®, ANDROID®, MS-WINDOWS®, OS/2®, UNIX®, LINUX®, or another known operating system. In some implementations, the I/O controller 908 may be implemented as part of a processor, such as the processor 906. In some implementations, a user may interact with the device 900 via the I/O controller 908 or via hardware components controlled by the I/O controller 908.

In some implementations, the device 900 may include a single antenna 910. However, in some other implementations, the device 900 may have more than one antenna 910 (i.e., multiple antennas), including multiple antenna panels or antenna arrays, which may be capable of concurrently transmitting or receiving multiple wireless transmissions. The transceiver 906 may communicate bi-directionally, via the one or more antennas 910, wired, or wireless links as described herein. For example, the transceiver 906 may represent a wireless transceiver and may communicate bi-directionally with another wireless transceiver. The transceiver 906 may also include a modem to modulate the packets, to provide the modulated packets to one or more antennas 910 for transmission, and to demodulate packets received from the one or more antennas 910. The transceiver 906 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 910 for transmitting the amplified signal into the air or wireless medium.

A receive chain may be configured to receive signals (e.g., control information, data, packets) over a wireless medium. For example, the receive chain may include one or more antennas 910 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

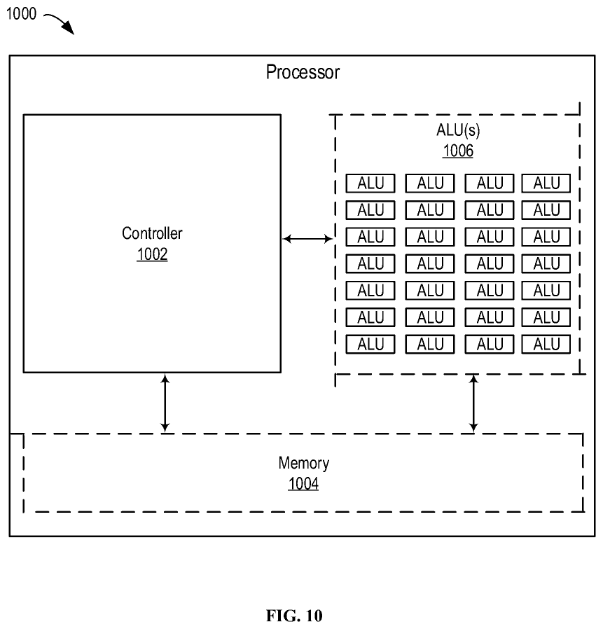

FIG. 10 illustrates an example of a processor 1000 that is suitable for implementing some embodiments of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, such as L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and Others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support a means for operations described in some embodiments of the present disclosure.

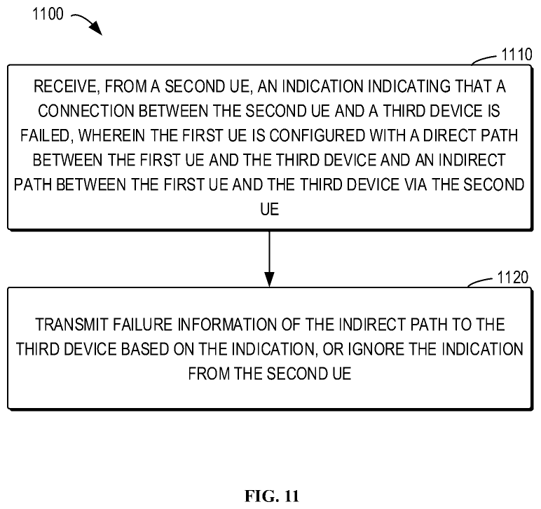

FIG. 11 illustrates a flowchart of a method 1100 performed by a first UE in accordance with aspects of the present disclosure. The operations of the method 1100 may be implemented by a device or its components as described herein. For example, the operations of the method 1100 may be performed by the first UE 241 in FIG. 2D or the first remote UE 810 in FIG. 8A. In some implementations, the device may execute a set of instructions to control the function elements of the device to perform the described functions. Additionally, or alternatively, the device may perform aspects of the described functions using special-purpose hardware.

At 1110, the method may include receiving, from a second UE, an indication indicating that a connection between the second UE and a third device is failed, wherein the first UE is configured with a direct path between the first UE and the third device and an indirect path between the first UE and the third device via the second UE. The operations of 1110 may be performed in accordance with examples as described herein. In some implementations, aspects of the operations of 1110 may be performed by the first UE 241 as described with reference to FIG. 2D or the first remote UE 810 as described with reference to FIG. 8A.

At 1120, the method may include transmitting failure information of the indirect path to the third device based on the indication, or ignoring the indication from the second UE. The operations of 1120 may be performed in accordance with examples as described herein. In some implementations, aspects of the operations of 1120 may be performed by the first UE 241 as described with reference to FIG. 2D or the first remote UE 810 as described with reference to FIG. 8A.

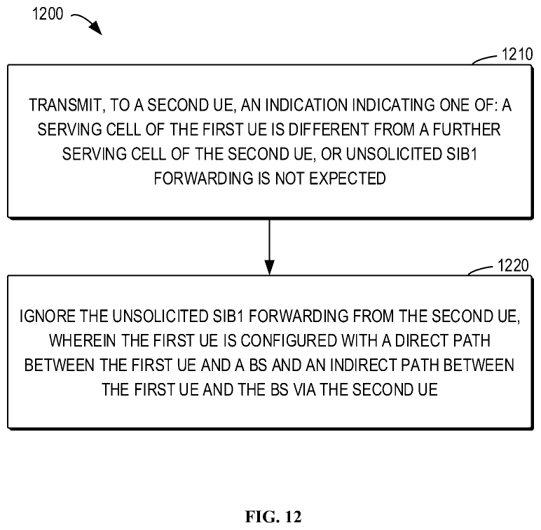

FIG. 12 illustrates a flowchart of a method 1200 performed by a first UE in accordance with aspects of the present disclosure. The operations of the method 1200 may be implemented by a device or its components as described herein. For example, the operations of the method 1200 may be performed by the first UE 241 in FIG. 2D. In some implementations, the device may execute a set of instructions to control the function elements of the device to perform the described functions. Additionally, or alternatively, the device may perform aspects of the described functions using special-purpose hardware.

At 1210, the method may include transmitting, to a second UE, an indication indicating one of: a serving cell of the first UE is different from a further serving cell of the second UE, or unsolicited SIB1 forwarding is not expected. The operations of 1210 may be performed in accordance with examples as described herein. In some implementations, aspects of the operations of 1210 may be performed by the first UE 241 as described with reference to FIG. 2D.

At 1220, the method may include ignoring the unsolicited SIB1 forwarding from the second UE, wherein the first UE is configured with a direct path between the first UE and a BS and an indirect path between the first UE and the BS via the second UE. The operations of 1220 may be performed in accordance with examples as described herein. In some implementations, aspects of the operations of 1220 may be performed by the first UE 241 as described with reference to FIG. 2D.

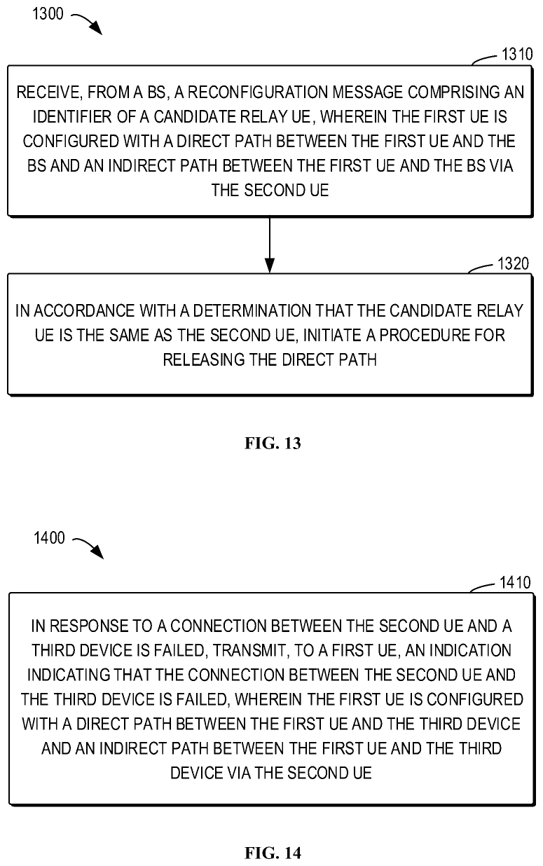

FIG. 13 illustrates a flowchart of a method 1300 performed by a first UE in accordance with aspects of the present disclosure. The operations of the method 1300 may be implemented by a device or its components as described herein. For example, the operations of the method 1300 may be performed by the first UE 241 in FIG. 2D. In some implementations, the device may execute a set of instructions to control the function elements of the device to perform the described functions. Additionally, or alternatively, the device may perform aspects of the described functions using special-purpose hardware.

At 1310, the method may include receiving, from a BS, a reconfiguration message comprising an identifier of a candidate relay UE, wherein the first UE is configured with a direct path between the first UE and the BS and an indirect path between the first UE and the BS via the second UE. The operations of 1310 may be performed in accordance with examples as described herein. In some implementations, aspects of the operations of 1310 may be performed by the first UE 241 as described with reference to FIG. 2D.

At 1320, the method may include in accordance with a determination that the candidate relay UE is the same as the second UE, initiating a procedure for releasing the direct path. The operations of 1320 may be performed in accordance with examples as described herein. In some implementations, aspects of the operations of 1320 may be performed by the first UE 241 as described with reference to FIG. 2D.

FIG. 14 illustrates a flowchart of a method 1400 performed by a second UE in accordance with aspects of the present disclosure. The operations of the method 1400 may be implemented by a device or its components as described herein. For example, the operations of the method 1400 may be performed by the second UE 242 in FIG. 2D. In some implementations, the device may execute a set of instructions to control the function elements of the device to perform the described functions. Additionally, or alternatively, the device may perform aspects of the described functions using special-purpose hardware.

At 1410, the method may include in response to a connection between the second UE and a third device is failed, transmitting, to a first UE, an indication indicating that the connection between the second UE and the third device is failed, wherein the first UE is configured with a direct path between the first UE and the third device and an indirect path between the first UE and the third device via the second UE. The operations of 1410 may be performed in accordance with examples as described herein. In some implementations, aspects of the operations of 1410 may be performed by the second UE 242 as described with reference to FIG. 2D.

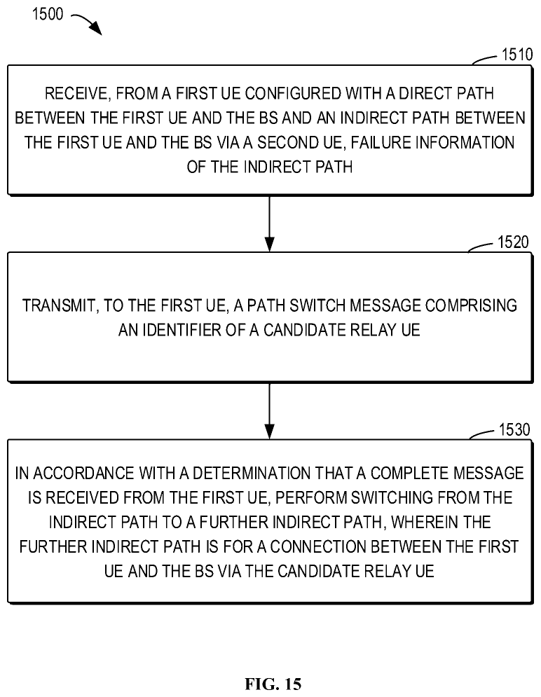

FIG. 15 illustrates a flowchart of a method 1500 performed by a BS in accordance with aspects of the present disclosure. The operations of the method 1500 may be implemented by a device or its components as described herein. For example, the operations of the method 1500 may be performed by the BS 243 in FIG. 2D. In some implementations, the device may execute a set of instructions to control the function elements of the device to perform the described functions. Additionally, or alternatively, the device may perform aspects of the described functions using special-purpose hardware.

At 1510, the method may include receiving, from a first UE configured with a direct path between the first UE and the BS and an indirect path between the first UE and the BS via a second UE, failure information of the indirect path. The operations of 1510 may be performed in accordance with examples as described herein. In some implementations, aspects of the operations of 1510 may be performed by the BS 243 as described with reference to FIG. 2D.

At 1520, the method may include transmitting, to the first UE, a path switch message comprising an identifier of a candidate relay UE. The operations of 1520 may be performed in accordance with examples as described herein. In some implementations, aspects of the operations of 1520 may be performed by the BS 243 as described with reference to FIG. 2D.

At 1530, the method may include in accordance with a determination that a complete message is received from the first UE, performing switching from the indirect path to a further indirect path, wherein the further indirect path is for a connection between the first UE and the BS via the candidate relay UE. The operations of 1530 may be performed in accordance with examples as described herein. In some implementations, aspects of the operations of 1530 may be performed by the BS 243 as described with reference to FIG. 2D.

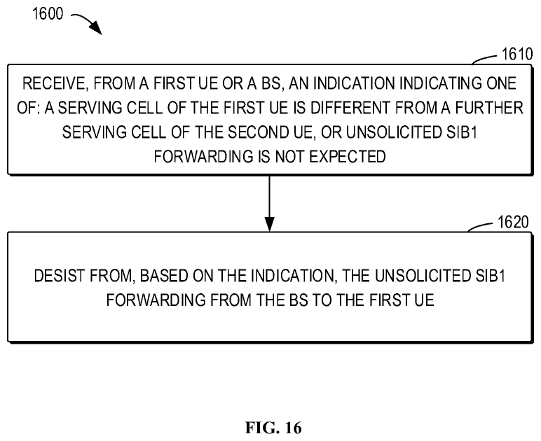

FIG. 16 illustrates a flowchart of a method 1600 performed by a second UE in accordance with aspects of the present disclosure. The operations of the method 1600 may be implemented by a device or its components as described herein. For example, the operations of the method 1600 may be performed by the second UE 242 in FIG. 2D. In some implementations, the device may execute a set of instructions to control the function elements of the device to perform the described functions. Additionally, or alternatively, the device may perform aspects of the described functions using special-purpose hardware.

At 1610, the method may include receiving, from a first UE or a BS, an indication indicating one of: a serving cell of the first UE is different from a further serving cell of the second UE, or unsolicited SIB1 forwarding is not expected. The operations of 1610 may be performed in accordance with examples as described herein. In some implementations, aspects of the operations of 1610 may be performed by the second UE 242 as described with reference to FIG. 2D.

At 1620, the method may include desisting from, based on the indication, the unsolicited SIB1 forwarding from the BS to the first UE, wherein the first UE is configured with a direct path between the first UE and the BS and an indirect path between the first UE and the BS via the second UE. The operations of 1620 may be performed in accordance with examples as described herein. In some implementations, aspects of the operations of 1620 may be performed by the second UE 242 as described with reference to FIG. 2D.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE) comprising:
at least one memory; and
at least one processor coupled with the at least one memory and configured to cause the first UE to:
receive, from a second UE, an indication indicating that a connection between the second UE and a third device is failed, wherein the first UE is configured with a direct path between the first UE and the third device and an indirect path between the first UE and the third device via the second UE; and
transmit failure information of the indirect path to the third device based on the indication, or ignore the indication from the second UE.

2. The first UE of claim 1, wherein the third device is a base station (BS), and wherein the indication indicates one of the following:
a radio link failure (RLF) of a link between the second UE and the BS,
a handover of the second UE, or
a cell reselection of the second UE.

3. The first UE of claim 2, wherein the at least one processor is further configured to cause the first UE to:
receive, from the BS, a path switch message comprising an identifier of a candidate relay UE; and
perform, based on the path switch message, switching from the indirect path to a further indirect path, wherein the further indirect path is for a connection between the first UE and the BS via the candidate relay UE.

4. The first UE of claim 1, wherein the third device is a BS, and wherein the at least one processor is further configured to cause the first UE to:
in accordance with a determination that the indication indicates a handover of the second UE, ignore the indication.

5. The first UE of claim 1, wherein the indication is carried in a PC5 notification message.

6. The first UE of claim 1, wherein the indication comprises a PC5 unicast release message.

7. The first UE of claim 1, wherein the third device is a third UE, and wherein the indication indicates one of the following:
a PC5 RLF between the second UE and the third UE, or
a sidelink radio resource control (RRC) reconfiguration failure between the second UE and the third UE.

8. The first UE of claim 7, wherein the indication comprises a failure type indicating the sidelink RRC reconfiguration failure.

9. A first user equipment (UE) comprising:
at least one memory; and
at least one processor coupled with the at least one memory and configured to cause the first UE to:
receive, from a base station (BS), a reconfiguration message comprising an identifier of a candidate relay UE, wherein the first UE is configured with a direct path between the first UE and the BS and an indirect path between the first UE and the BS via a second UE; and
in accordance with a determination that the candidate relay UE is the same as the second UE, initiate a procedure for releasing the direct path.

10. The first UE of claim 9, wherein the at least one processor is further configured to cause the first UE to:
keep the indirect path unchanged; and
perform a primary cell (PCell) change from a first cell associated with the direct path to a second cell associated with the indirect path.

11. The first UE of claim 9, wherein the at least one processor is further configured to cause the first UE to:
in accordance with a determination that a timer for path addition or path change is running, determine to use resources configured in configured sidelink grant for the second UE.

12. A second user equipment (UE) comprising:
at least one memory; and
at least one processor coupled with the at least one memory and configured to cause the second UE to:
in response to a connection between the second UE and a third device is failed, transmit, to a first UE, an indication indicating that the connection between the second UE and the third device is failed, wherein the first UE is configured with a direct path between the first UE and the third device and an indirect path between the first UE and the third device via the second UE.

13. The second UE of claim 12, wherein the third device is a base station (BS), and wherein the indication indicates one of the following:
a radio link failure (RLF) of a link between the second UE and the BS,
a handover of the second UE, or
a cell reselection of the second UE.

14. The second UE of claim 12, wherein the indication is carried in a PC5 notification message.

15. The second UE of claim 12, wherein the indication comprises a PC5 unicast release message.

16. The second UE of claim 12, wherein the third device is a third UE, and wherein the indication indicates one of the following:
a PC5 RLF between the second UE and the third UE, or
a sidelink radio resource control (RRC) reconfiguration failure between the second UE and the third UE.

17. The second UE of claim 16, wherein the indication comprises a failure type indicating the sidelink RRC reconfiguration failure.

18. (canceled)

19. (canceled)

20. A first user equipment (UE) comprising:
at least one memory; and
at least one processor coupled with the at least one memory and configured to cause the first UE to:
receive configuration information that configures a direct path between the first UE and a third device and an indirect path between the first UE and the third device via a second UE.

21. The first UE of claim 20, wherein the at least one processor is configured to cause the first UE to ignore an unsolicited system information block received from the second UE.

22. The first UE of claim 20, wherein the third device comprises a base station.
